(19) United States
(12) Patent Application Publication
(10) Pub. No.: US 2024/0171259 A1
(43) Pub. Date: May 23, 2024

(54) NR AIR-TO-GROUND SIGNALING ENHANCEMENT FOR EARLY INDICATION OF AIR-TO-GROUND CELL

(71) Applicant: QUALCOMM Incorporated, San Diego, CA (US)

(72) Inventors: Qiaoyu LI, Beijing (CN); Yu ZHANG, San Diego, CA (US); Chao WEI, Beijing (CN); Hao XU, Beijing (CN)

(21) Appl. No.: 18/551,333

(22) PCT Filed: May 25, 2021
(86) PCT No.: PCT/CN2021/095698

§ 371 Date: Sep. 19, 2023

(51) Int. Cl. H04B 7/185

(52) U.S. Cl. CPC H04B 7/18506

(57) ABSTRACT

Various aspects of the present disclosure generally relate to wireless communication. In some aspects, a user equipment (UE) may receive, from a base station, one or more communications associated with accessing a cell associated with the base station. The UE may selectively access the cell associated with the base station based at least in part on a determination of whether the one or more communications provide an indication that the cell is dedicated for air-to-ground communications. Numerous other aspects are described.

### FIELD OF THE DISCLOSURE

Aspects of the present disclosure generally relate to wireless communication and to techniques and apparatuses for air-to-ground (ATG) signaling enhancement for early indication of an ATG cell.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a user equipment (UE) for wireless communication includes a memory, and one or more processors, coupled to the memory, configured to: receive, from a base station, one or more communications associated with accessing a cell associated with the base station; and selectively access the cell associated with the base station based at least in part on a determination of whether the one or more communications provide an indication that the cell is dedicated for air-to-ground (ATG) communications.

In some aspects, a method of wireless communication performed by a UE includes receiving, from a base station, one or more communications associated with accessing a cell associated with the base station; and selectively accessing the cell associated with the base station based at least in part on a determination of whether the one or more communications provide an indication that the cell is dedicated for ATG communications.

In some aspects, a non-transitory computer-readable medium storing a set of instructions for wireless communication includes one or more instructions that, when executed by one or more processors of a UE, cause the UE to: receive, from a base station, one or more communications associated with accessing a cell associated with the base station; and selectively access the cell associated with the base station based at least in part on a determination of whether the one or more communications provide an indication that the cell is dedicated for ATG communications.

In some aspects, an apparatus for wireless communication includes means for receiving, from a base station, one or more communications associated with accessing a cell associated with the base station; and means for selectively accessing the cell associated with the base station based at least in part on a determination of whether the one or more communications provide an indication that the cell is dedicated for ATG communications.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, radio frequency (RF) chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of an air-to-ground (ATG) network, in accordance with the present disclosure.

FIG. 4 is a diagram illustrating an example of numerologies for orthogonal frequency division multiplexing (OFDM) based communications, in accordance with the present disclosure.

FIG. 5 is a diagram illustrating an example associated with ATG signaling enhancement for early indication of an ATG cell, in accordance with the present disclosure.

FIG. 6 is a diagram illustrating an example process associated with ATG signaling enhancement for early indication of an ATG cell, in accordance with the present disclosure.

FIG. 7 is a block diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

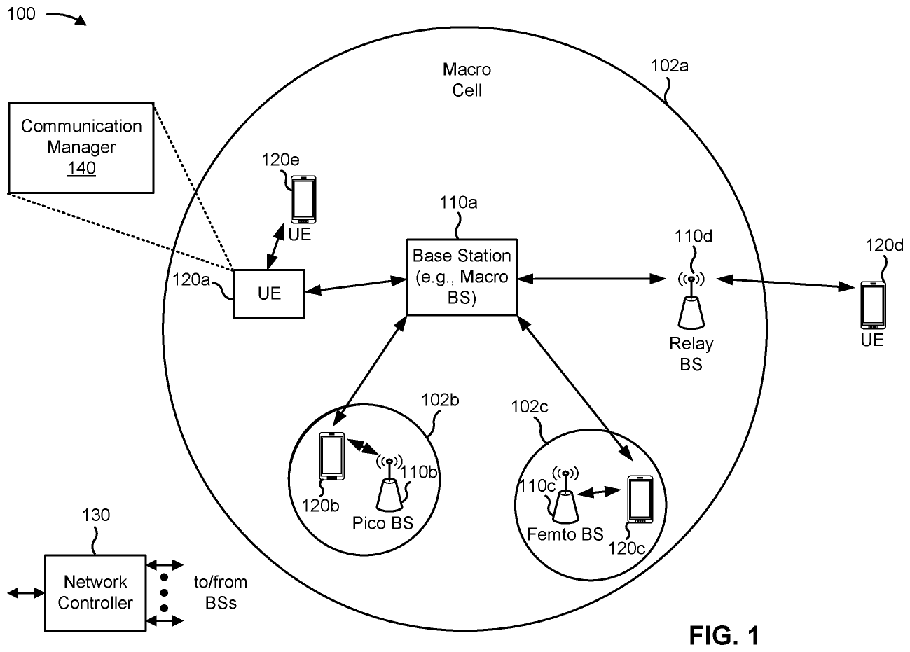

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IOT) devices, and/or may be implemented as NB-IOT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In some aspects, some UEs may be air-to-ground (ATG) UEs. An ATG UE is an onboard terminal on an aircraft that communicates with a ground-based ATG base station. Such an ATG UE may also be referred to as an “ATG terminal.” In some aspects, an ATG UE may be considered a CPE for an aircraft and may provide network connectivity (e.g., via Wi-Fi or a small cell network) to other UEs on the aircraft, such as UEs belonging to passengers of the aircraft. In some aspects, some base stations may be ATG base stations. An ATG base station is a base station (e.g., an NR gNB) that performs ATG communications with an ATG UE.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

In some aspects, the UE 120 may include a communication manager 140. As described in more detail elsewhere herein, the communication manager 140 may receive, from a base station, one or more communications associated with accessing a cell associated with the base station; and selectively access the cell associated with the base station based at least in part on a determination of whether the one or more communications provide an indication that the cell is dedicated for air-to-ground communications. Additionally, or alternatively, the communication manager 140 may perform one or more other operations described herein.

As indicated above, FIG. 1 is provided as an example. Other examples may differ from what is described with regard to FIG. 1.

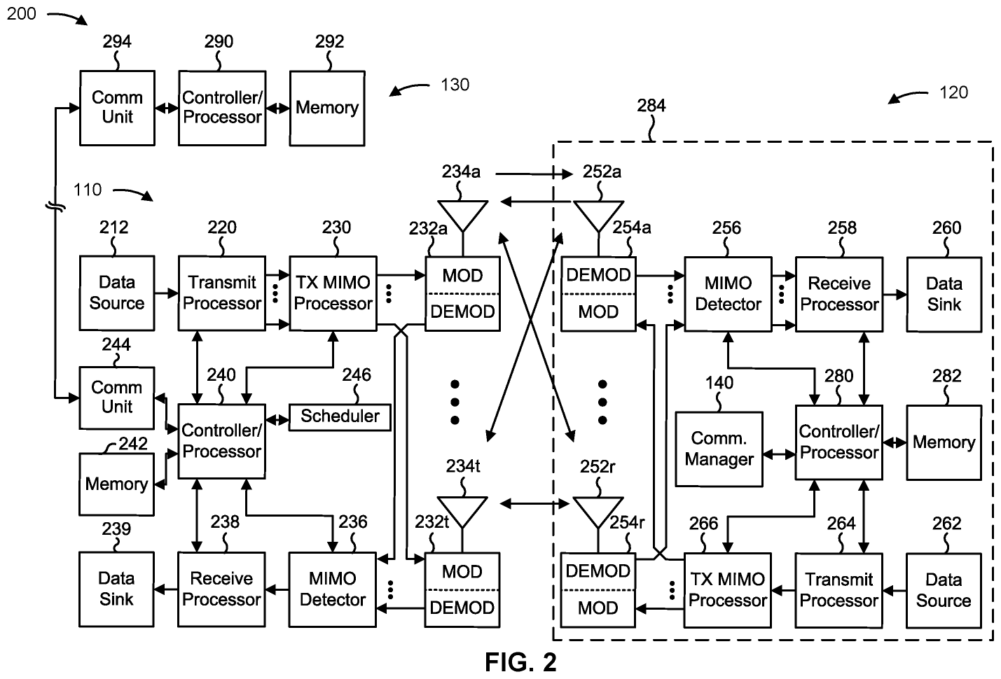

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

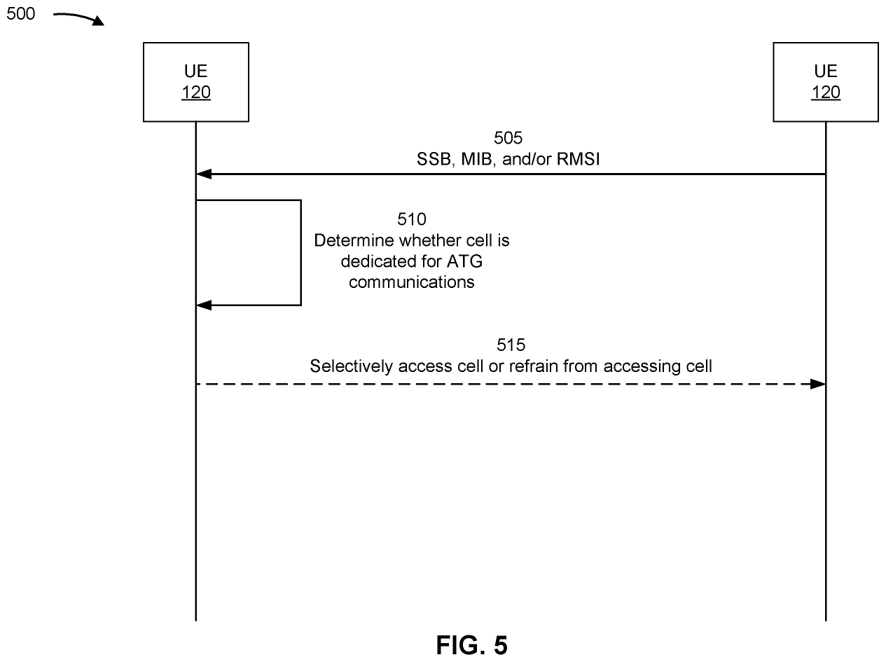

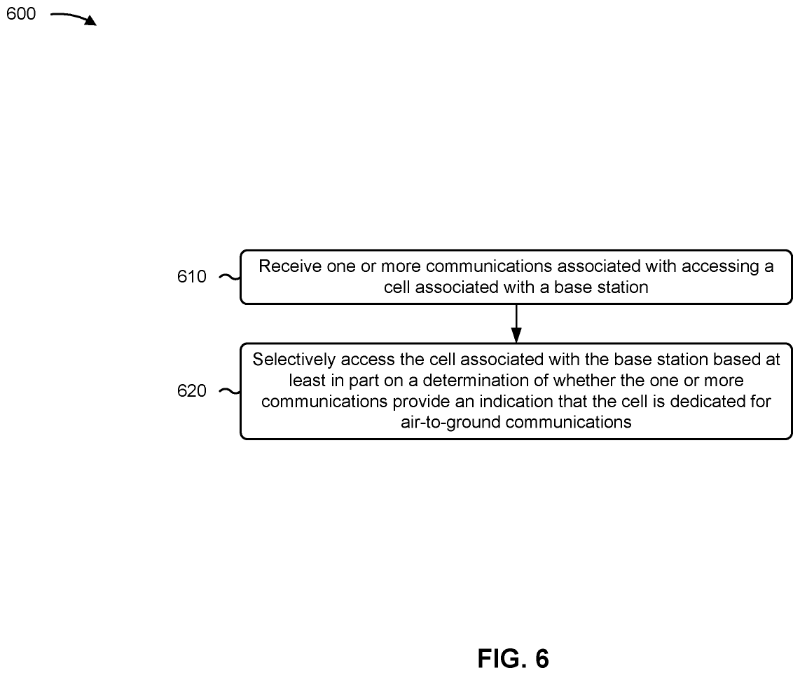

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 5-6).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 5-6).

Controller/processor 240 of base station 110, controller/processor 280 of UE 120, and/or any other component(s) of FIG. 2 may perform one or more techniques associated with ATG signaling enhancement for early indication of an ATG cell, as described in more detail elsewhere herein. For example, controller/processor 240 of base station 110, controller/processor 280 of UE 120, and/or any other component(s) of FIG. 2 may perform or direct operations of, for example, process 600 of FIG. 6, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, and/or other processes as described herein. In some aspects, executing instructions may include running the instructions, converting the instructions, compiling the instructions, and/or interpreting the instructions, among other examples.

In some aspects, the UE 120 includes means for receiving, from a base station, one or more communications associated with accessing a cell associated with the base station; and/or means for selectively accessing the cell associated with the base station based at least in part on a determination of whether the one or more communications provide an indication that the cell is dedicated for air-to-ground communications. The means for the UE 120 to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

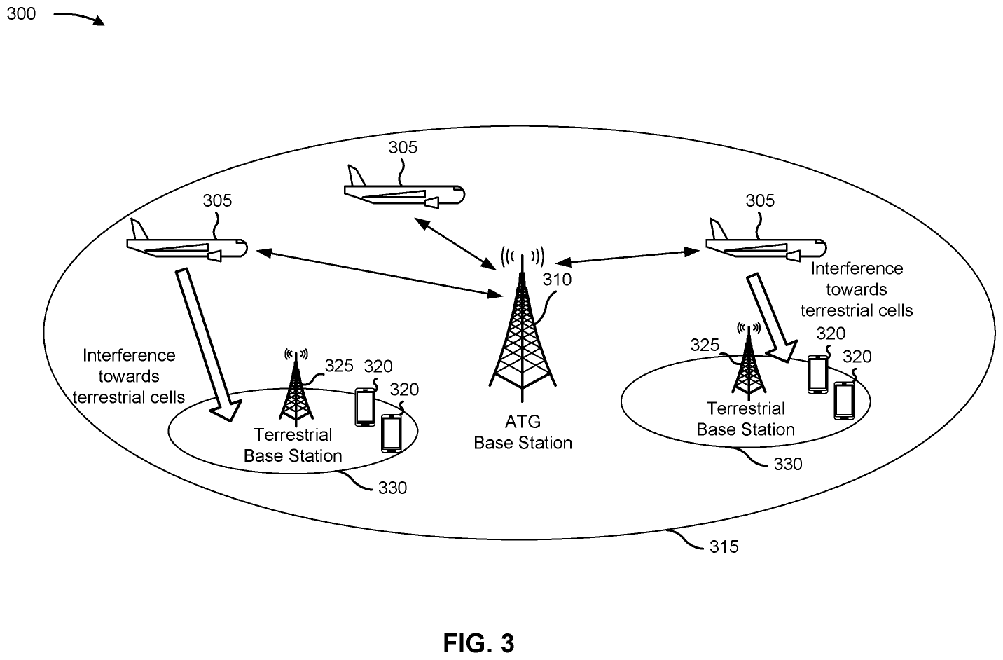

FIG. 3 is a diagram illustrating an example 300 of an ATG network, in accordance with the present disclosure. In some aspects, the ATG network may be a 5G/NR network.

As shown in FIG. 3, the ATG network may include one or more ATG UEs 305 and an ATG base station 310. The ATG UE 305 may be, may include, or may be included in an onboard terminal and/or CPE on an aircraft. The ATG UE 305 may include components of UE 120 described elsewhere herein. The ATG base station 310 may be a ground-based base station (e.g., a 5G/NR gNB) that transmits signals to and receives signals from the ATG UEs 305. The ATG base station 310 may include components of base station 110 described elsewhere herein. In some aspects, the ATG UE 305 may communicate with the ATG base station 310 to provide network connectivity (e.g., via Wi-Fi or a small cell network) to other UEs on the aircraft, such as UEs belonging to passengers of the aircraft.

In some aspects, a cell 315 associated with the ATG base station may have an extremely large coverage range, such as up to 300 km. In some cases, the ATG UEs 305 and ATG base station 310, in the ATG network, may communicate using a same frequency band as terrestrial UEs 320 and terrestrial base stations 325 in terrestrial networks. As used herein, “terrestrial UE” may refer to any UE that is not an ATG UE, and “terrestrial base station” may refer to any base station that is not an ATG base station. In some aspects, an ATG UE 305 may be more powerful than a terrestrial UE 320. For example, the ATG UE 305 may transmit with a higher effective isotropic radiated power (EIRP), via a larger transmission power and/or a larger on-board antenna gain, as compared with the terrestrial UE 320.

ATG channel power delay profile (PDP) and Doppler measurements may be significantly higher than such measurements in a terrestrial network. In some cases, due to such large ATG channel PDP and Doppler measurements, the ATG UEs 305 and the ATG base station 310 may use different numerologies for OFDM communications, as compared to terrestrial networks. The numerology for OFDM refers to a configuration of waveform parameters, such as subcarrier spacing (SCS), OFDM symbol duration, cyclic prefix (CP), total symbol duration, and/or number of OFDM symbols per slot. Different numerologies may correspond to different sets of configured OFDM waveform parameters.

The PDP for an ATG UE 305 may vary due to a flight stage (e.g., en route cruise, climb and descent, or takeoff and landing), terrain (e.g., mountains), or the presence of other obstacles (e.g., buildings) that may affect line of sight (LoS) between the ATG UE 305 and the ATG base station 310. For example, mountains may cause a large multipath delay for an ATG UE 305. In some examples, a distinctive delay for an ATG UE 305 may approach 2.5 km (or 8.33 μs). In some aspects, for OFDM communications, a numerology with a CP that is greater than the delay may be used to avoid inter-symbol interference. Doppler measurements may be based at least in part on a speed of the aircraft. In some examples, an aircraft including an ATG UE 305 may travel at speeds up to 1200 km/hour. In some aspects, a numerology with a large SCS may be used to compensate for large a Doppler spread (e.g., due to multipath Doppler measurements) for an ATG UE 305.

In cases in which an ATG network and a terrestrial network co-exist, a possible way to multiplex ATG communications and terrestrial network communications is using frequency division multiplexing (FDM). However, multiplexing ATG communications and terrestrial network communications using FDM may suffer from spectral inefficiency. Another more spectral-efficient way to multiplex ATG communications and terrestrial network communications is to allow non-orthogonal use of radio frequencies among ATG communications and terrestrial network communications. However, as shown in FIG. 3, interference from ATG UEs 305 toward terrestrial cells 330 may adversely affect communications between terrestrial UEs 320 and terrestrial base stations 325. In time division duplexing (TDD), the ATG UE 305 may cause interference to uplink reception by the terrestrial base station 325 and/or interference to downlink reception by the terrestrial UEs 320. In frequency division duplexing (FDD), the ATG UE 305 may cause interference to uplink reception by the terrestrial base station 325, or, in a case in which the uplink and downlink frequency bands are used in reverse for ATG communications, may cause interference to downlink reception by the terrestrial UEs 320. Such interference, from the ATG UEs 305, may not be synchronized to the communications in the terrestrial cells 330. For example, interference from different space division multiplexed ATG UEs 305 may be asynchronized due to different propagation delays. Furthermore, the ATG communications may use different numerologies or waveforms from the terrestrial network communications.

As indicated above, FIG. 3 is provided as an example. Other examples may differ from what is described with respect to FIG. 3.

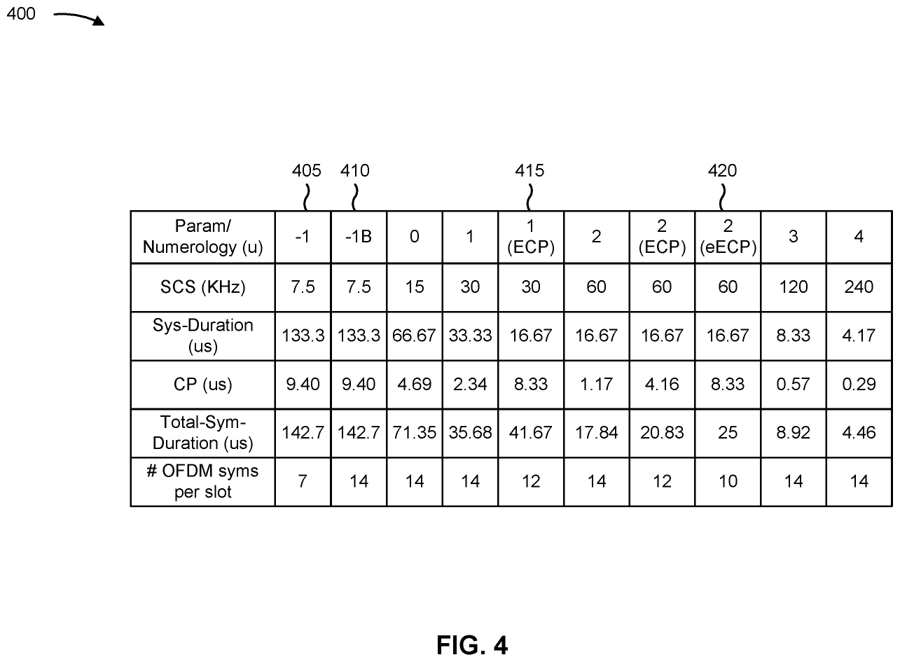

FIG. 4 is a diagram illustrating an example 400 of numerologies for orthogonal OFDM-based communications, in accordance with the present disclosure.

As shown in FIG. 4, each numerology may correspond to a respective set of OFDM waveform parameters, and each numerology may be identified using a respective numerology parameter (u). As described above, in some aspects, ATG communications may use different numerologies than terrestrial network communications. As shown in FIG. 4, reference numbers 405, 410, 415, and 420 show example numerologies configured for ATG communications. In some aspects, a numerology for ATG communications with SCS=7.5 kHz at a frequency of 700 MHz may be determined by doubling the OFDM waveform parameters in the numerology u=0 (SCS=15 kHz), resulting in a CP of 9.40 μs. As shown by reference number 405, a first numerology (e.g., u=−1) may be configured for SCS=7.5 kHz at 700 MHz with a slot that occupies 1 ms with 7 symbols. As shown by reference number 410, a second numerology (e.g., u=−1B) may be configured for SCS=7.5 at 700 kHz with a slot that occupies 2 ms with 14 symbols. As shown by reference number 415, a numerology (e.g., u=1 (ECP)) may be configured for SCS=30 kHz at a frequency of 3.5 GHz with an extended CP (ECP) of 8.33 μs and 12 symbols per slot. As shown by reference number 420, a numerology (e.g., u=2 (eECP)) may be configured for SCS=60 kHz at a frequency of 4.8 GHz with an extended ECP (eECP) of 8.33 μs and 10 symbols per slot.

As indicated above, FIG. 4 is provided as an example. Other examples may differ from what is described with respect to FIG. 4.

In some cases, an ATG UE may access a cell associated with a terrestrial base station. In such a case, accessing a terrestrial cell, by the ATG UE, will lead to handover from the non-terrestrial base station to an ATG base station, which may result in increased traffic latency and/or control signaling overhead. However, the ATG UE may not be able to identify whether a cell is an ATG cell when performing an initial access procedure to access the cell.

Some techniques and apparatuses described herein enable, a UE, such as an ATG UE, to receive, from a base station, one or more communications associated with accessing a cell associated with the base station. The UE may selectively access the cell associated with the base station based at least in part on a determination of whether the one or more communications provide an indication that the cell is dedicated for ATG communications. In some aspects, the UE may access the cell based at least in part on determining that the one or more communications provide the indication that the cell is dedicated for ATG communications. In some aspects, based at least in part on a determination that the one or more communications do not provide the indication that the cell is dedicated for ATG communications, the UE may select whether to access the cell based at least in part on a selection criteria configured for the UE. As a result, an ATG UE may know whether a cell is a terrestrial cell or an ATG cell, and the ATG-UE may refrain from accessing a terrestrial cell in situations, such as while in flight, in which a handover to an ATG cell may be needed within a short period of time. This may result in decreased handovers, and thus, decreased traffic latency and control overhead for the UE.

FIG. 5 is a diagram illustrating an example 500 associated with ATG signaling enhancement for early indication of an ATG cell, in accordance with the present disclosure. As shown in FIG. 5, example 500 includes communication between a base station 110 and a UE 120. In some aspects, the base station 110 and the UE 120 may be included in a wireless network, such as wireless network 100. The base station 110 and the UE 120 may communicate via a wireless access link, which may include an uplink and a downlink. In some aspects, the UE 120 may be an ATG UE (e.g., ATG UE 305), as described elsewhere herein.

As shown in FIG. 5, and by reference number 505, the UE 120 may receive, from the base station 110, one or more communications associated with accessing a cell associated with the base station 110. For example, the base station 110 may transmit, and the UE 120 may receive, a synchronization signal block (SSB), a master information block (MIB), and/or a system information block (SIB), such as a type 1 system information block (SIB1) including remaining minimum system information (RMSI).

The base station 110 may transmit multiple SSBs. For example, the base station 110 may transmit multiple SSBs on different beams in an SSB burst set. The UE 120 may search for the SSBs and detect an SSB with a strongest signal strength for the UE 120. The SSB may include a PSS and an SSS. The base station 110 may transmit the MIB on physical broadcast channel associated with the SSB. Based at least in part on detecting the SSB, the UE 120 may receive and decode the MIB. The MIB may include a configuration of a control resource set (CORESET) type 0 (CORESET #0), which is a CORESET used to transmit a type 0 physical downlink control channel (PDCCH) communication that schedules the SIB1 transmission. The UE 120 may decode the type 0 PDCCH communication, transmitted by the base station 110, and receive the SIB1, including the RMSI, from the base station 110. The RMSI may include network access parameters for the cell associated with the base station 110 and scheduling information for other system information (e.g., other SIBs).

In a case in which the base station 110 is an ATG base station, the base station 110 may provide an indication, in at least one of the communications associated with accessing the cell, that the cell associated with the base station 110 is dedicated for ATG communications (e.g., the cell is an ATG cell). In some aspects, the base station 110 may include, in the SSB, a PSS sequence that is associated with an indication that the cell is dedicated for ATG communications. For example, the PSS may include a special sequence that is associated with an ATG cell indication on an upper or lower side of the PSS. In some aspects, the base station 110 may include, in the SSB, an SSS sequence that is associated with an indication that the cell is dedicated for ATG communications.

In some aspects, the base station 110 may provide the indication by scrambling a PBCH communication (e.g., the PBCH communication including the MIB) using a PBCH scrambling sequence that is associated with an indication that the cell is dedicated for ATG communications. For example, the PBCH scrambling sequence may be based at least in part on a cell identifier (ID) that identifies the cell associated with the base station 110 as an ATG cell, or the PBCH scrambling sequence may be scrambled using a scrambling formula associated with an ATG cell.

In some aspects, the base station 110 may include the indication that the cell is dedicated for ATG communications in the MIB. For example, one or more invalid or reserved bit-points in the MIB may be used to indicate whether the cell associated with the base station 110 is an ATG cell. In some aspects, the base station 110 may include the indication that the cell is dedicated for ATG communications in the RMSI. For example, one or more bit-points in the RMSI may be used to indicate whether the cell associated with the base station 110 is an ATG cell.

In a case in which the base station 110 is not an ATG base station (e.g., the base station 110 is a terrestrial base station), the base station 110 may not provide an indication that the cell is dedicated for ATG communications.

As further shown in FIG. 5, and by reference number 510, the UE 120 may determine, based at least in part on the one or more communications associated with accessing the cell, whether the cell is dedicated for ATG communications. For example, the UE 120 may determine whether the cell is dedicated for ATG communications by determining whether or not the one or more communications provide an indication that the cell is dedicated for ATG communications.

In some aspects, the UE 120 may determine whether the SSB includes a PSS sequence that indicates that the cell is dedicated for ATG communications. For example, the UE 120 may determine whether the PSS includes a special sequence that is associated with an ATG cell indication on an upper or lower side of the PSS. In some aspects, the UE 120 may determine whether the SSB includes an SSS sequence that indicates that the cell is dedicated for ATG communications.

In some aspects, the UE 120 may determine whether a PBCH scrambling sequence, used to scramble a PBCH communication (e.g., the PBCH communication including the MIB), indicates that the cell is dedicated for ATG communications. For example, the UE 120 may determine whether the PBCH scrambling sequence is a scrambling sequence associated with a cell ID for an ATG cell, or the UE 120 may determine whether the PBCH scrambling sequence is scrambled using a scrambling formula associated with an ATG cell.

In some aspects, the UE 120 may determine whether the MIB includes the indication that the cell is dedicated for ATG communications. For example, the UE 120 may determine whether the cell is dedicated for ATG communications based at least in part on a value of a bit-point in the MIB. In some aspects, the UE 120 may determine whether the RMSI includes the indication that the cell is dedicated for ATG communications. For example, the UE 120 may determine whether the cell is dedicated for ATG communications based at least in part on a value of a bit-point in the RMSI.

As further shown in FIG. 5, and by reference number 515, the UE 120 may selectively access the cell based at least in part on the determination of whether the cell is dedicated for ATG communications. For example, the UE 120 may select whether to access the cell or refrain from accessing the cell based at least in part on the determination of whether the one or more communications associated with accessing the cell provide the indication that the cell is dedicated for ATG communications.

In some aspects, the UE 120 may select to access the cell based at least in part on a determination that the cell is dedicated for ATG communications. For example, the UE 120 may access the cell based at least in part on determining that the one or more communications provide the indication that the cell is dedicated for ATG communications. In this case, the UE 120 may perform (or complete) an initial access procedure to access the cell. For example, the initial access procedure may include a random access channel (RACH) procedure to establish a radio resource control (RRC) connection with the base station 110.

In some aspects, the UE 120 may determine that the cell is not dedicated for ATG communications. For example, the UE 120 may determine that the one or more communications associated with accessing the cell do not provide an indication that the cell is dedicated for ATG communications. In this case, the UE 120 may select whether to access the cell or refrain from accessing the cell based at least in part on selection criteria or rules configured or defined for the UE 120. For example, the selection criteria may be predefined (e.g., in a wireless communication standard), or the selection criteria may be configured for the UE 120 by information received from the base station 110 (e.g., in the RMSI or other system information (OSI) received in an SIB other than SIB1).

In some aspects, based at least in part on a determination that there is no indication that the cell is dedicated for ATG communications, the UE 120 may select whether to access the cell based at least in part on an RSRP measurement of the SSB performed by the UE 120. In this case, the UE 120 may access the cell (e.g., by performing the initial access procedure) based at least in part on a determination that the RSRP measurement of the SSB satisfies a threshold. The UE 120 may refrain from accessing the cell based at least in part on a determination that the RSRP measurement of the SSB does not satisfy the threshold. For example, the threshold may be predefined (e.g., in a wireless communication standard) or the threshold may be configured in the RMSI or OSI.

In some aspects, in a case in which there is no indication that the cell is dedicated for ATG communications, the UE 120 may select whether to access the cell based at least in part on a determination of whether the RSRP measurement of the SSB satisfies a threshold for a certain time duration. In this case, the UE 120 may access the cell based at least in part on the determination that the RSRP measurement of the SSB satisfies the threshold for the time duration. The UE 120 may refrain from accessing the cell based at least in part on a determination that the RSRP measurement of the SSB does not satisfy the threshold for the time duration. For example, the threshold and the time duration may be predefined (e.g., in a wireless communication standard) or configured in the RMSI or OSI. This may provide a benefit of allowing an ATG UE to access a terrestrial cell in situations in which the RSRP measurement of the SSB for the terrestrial cell is sufficiently high. For example, such an RSRP measurement may correspond to a scenario in which it is beneficial for the ATG UE to connect to a terrestrial cell, such as when an aircraft in which the ATG UE is located, is on the ground.

In some aspects, based at least in part on determining that there is no indication that the cell is dedicated for air-to-ground communications, the UE 120 may measure a PDP and/or a Doppler measurement for a reference signal, and the UE 120 may selectively access the cell based at least in part on the PDP and/or Doppler measurement. For example, the reference signal used by the UE 120 to measure the PDP and/or Doppler measurement may be a newly introduced reference signal or an existing reference signal, such as the SSB or a DMRS received from the base station 110. In some aspects, the UE 120 access the cell based at least in part on a determination that the PDP satisfies a PDP threshold and/or a determination that the Doppler measurement satisfies a Doppler threshold. The UE 120 may refrain from accessing the cell based at least in part on a determination that the PDP does not satisfy the PDP threshold and/or a determination that the Doppler measurement does not satisfy the Doppler threshold. This may provide a benefit of allowing an ATG UE to access a terrestrial cell in a scenario in which it is beneficial for the ATG UE to connect to a terrestrial cell, such as when an aircraft in which the ATG UE is located, is on the ground.

In some aspects, the UE 120 may transmit, to the base station 110, an indication of the PDP and/or Doppler measurement. For example, the UE 120 may transmit the indication of the PDP and/or Doppler measurement via a message A physical uplink shared channel (PUSCH) communication in a two-step RACH procedure, via a message 3 (Msg3) PUSCH communication in a four-step RACH procedure, or via a UE capability report. In this case, the base station 110 may determine, based at least in part on the PDP and/or Doppler measurement, whether to schedule the UE 120 with subsequent communications (e.g., in a RACH procedure) to allow the UE 120 to access the cell. In some aspects, the base station 110 may transmit, to the UE 120, an indication of whether to access the cell based at least in part on the PDP and Doppler measurement.

As described above in connection with FIG. 5, the UE 120, which may be an ATG UE, may receive, from the base station 110, one or more communications associated with accessing a cell associated with the base station 110. The UE 120 may selectively access the cell associated with the base station 110 based at least in part on a determination of whether the one or more communications provide an indication that the cell is dedicated for ATG communications. In some aspects, the UE 120 may access the cell based at least in part on determining that the one or more communications provide the indication that the cell is dedicated for ATG communications. In some aspects, based at least in part on a determination that the one or more communications do not provide the indication that the cell is dedicated for ATG communications, the UE 120 may select whether to access the cell based at least in part on selection criteria configured for the UE 120. As a result, an ATG UE may know whether a cell is a terrestrial cell or an ATG cell and may refrain from accessing a terrestrial cell in situations, such as while in flight, in which a handover to an ATG cell may be needed within a short period of time. This may result in decreased handovers, and thus, decreased traffic latency and control overhead for the UE.

As indicated above, FIG. 5 is provided as an example. Other examples may differ from what is described with respect to FIG. 5.

FIG. 6 is a diagram illustrating an example process 600 performed, for example, by a UE, in accordance with the present disclosure. Example process 600 is an example where the UE (e.g., UE 120) performs operations associated with ATG signaling enhancement for early indication of an ATG cell.

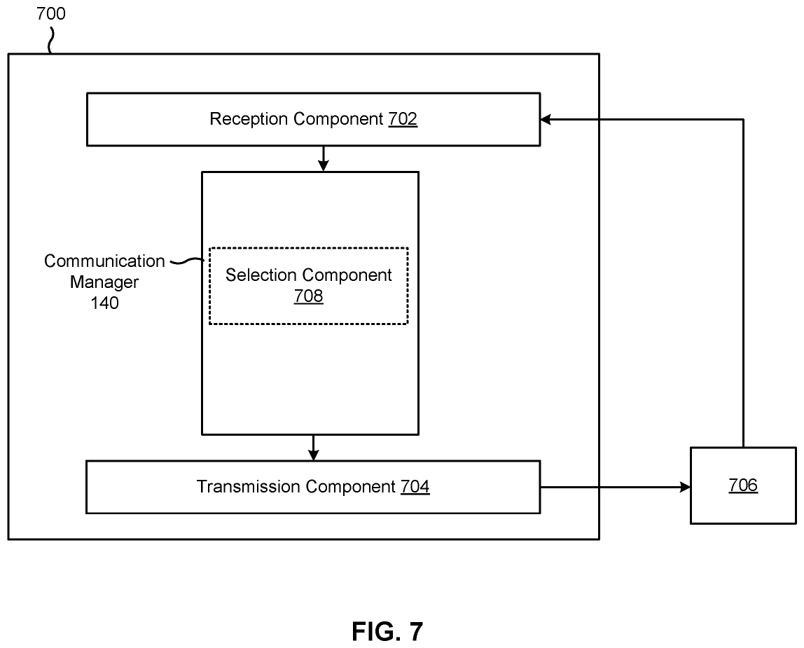

As shown in FIG. 6, in some aspects, process 600 may include receiving, from a base station, one or more communications associated with accessing a cell associated with the base station (block 610). For example, the UE (e.g., using communication manager 140 and/or reception component 702, depicted in FIG. 7) may receive, from a base station, one or more communications associated with accessing a cell associated with the base station, as described above.

As further shown in FIG. 6, in some aspects, process 600 may include selectively accessing the cell associated with the base station based at least in part on a determination of whether the one or more communications provide an indication that the cell is dedicated for ATG communications (block 620). For example, the UE (e.g., using communication manager 140 and/or selection component 708, depicted in FIG. 7) may selectively access the cell associated with the base station based at least in part on a determination of whether the one or more communications provide an indication that the cell is dedicated for air-to-ground communications, as described above.

Process 600 may include additional aspects, such as any single aspect or any combination of aspects described below and/or in connection with one or more other processes described elsewhere herein.

In a first aspect, the one or more communications include an SSB, and selectively accessing the cell associated with the base station includes selectively accessing the cell associated with the base station based at least in part on a determination of whether the SSB includes a PSS sequence that indicates that the cell is dedicated for ATG communications.

In a second aspect, alone or in combination with the first aspect, the one or more communications include an SSB, and selectively accessing the cell associated with the base station includes selectively accessing the cell associated with the base station based at least in part on a determination of whether the SSB includes an SSS sequence that indicates that the cell is dedicated for ATG communications.

In a third aspect, alone or in combination with one or more of the first and second aspects, the one or more communications include a PBCH communication, and selectively accessing the cell associated with the base station includes selectively accessing the cell associated with the base station based at least in part on a determination of whether a PBCH scrambling sequence indicates that the cell is dedicated for ATG communications.

In a fourth aspect, alone or in combination with one or more of the first through third aspects, the one or more communications include an MIB, and selectively accessing the cell associated with the base station includes selectively accessing the cell associated with the base station based at least in part on a determination of whether the MIB includes an indication that the cell is dedicated for ATG communications.

In a fifth aspect, alone or in combination with one or more of the first through fourth aspects, the one or more communications include an SIB including RMSI, and selectively accessing the cell associated with the base station includes selectively accessing the cell associated with the base station based at least in part on a determination of whether the RMSI includes an indication that the cell is dedicated for ATG communications.

In a sixth aspect, alone or in combination with one or more of the first through fifth aspects, selectively accessing the cell associated with the base station includes accessing the cell based at least in part on determining that the one or more communications provide the indication that the cell is dedicated for ATG communications.

In a seventh aspect, alone or in combination with one or more of the first through sixth aspects, the one or more communications include an SSB, and selectively accessing the cell associated with the base station includes, based at least in part on determining that the one or more communications do not provide the indication that the cell is dedicated for air-to-ground communications, accessing the cell based at least in part on a determination that a RSRP measurement of the SSB satisfies a threshold, or refraining from accessing the cell based at least in part on a determination that the RSRP measurement of the SSB does not satisfy the threshold.

In an eighth aspect, alone or in combination with one or more of the first through seventh aspects, the one or more communications include an SSB, and selectively accessing the cell associated with the base station includes, based at least in part on determining that the one or more communications do not provide the indication that the cell is dedicated for air-to-ground communications, accessing the cell based at least in part on a determination that a RSRP measurement of the SSB satisfies a threshold for a time duration, or refraining from accessing the cell based at least in part on a determination that the RSRP measurement of the SSB does not satisfy the threshold for the time duration.

In a ninth aspect, alone or in combination with one or more of the first through eighth aspects, selectively accessing the cell associated with the base station includes, based at least in part on determining that the one or more communications do not provide the indication that the cell is dedicated for air-to-ground communications, measuring at least one of a power delay profile or Doppler measurement for a reference signal, and selectively accessing the cell based at least in part on the at least one of the power delay profile or the Doppler measurement.

In a tenth aspect, alone or in combination with one or more of the first through ninth aspects, the reference signal is a synchronization signal block or a demodulation reference signal.

In an eleventh aspect, alone or in combination with one or more of the first through tenth aspects, selectively accessing the cell associated with the base station includes, based at least in part on determining that the one or more communications do not provide the indication that the cell is dedicated for air-to-ground communications, measuring at least one of a power delay profile or Doppler measurement for a reference signal, and receiving, from the base station, an indication of whether to access the cell.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a block diagram of an example apparatus 700 for wireless communication. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include the communication manager 140. The communication manager 140 may include a selection component 708, among other examples.

In some aspects, the apparatus 700 may be configured to perform one or more operations described herein in connection with FIG. 5. Additionally, or alternatively, the apparatus 700 may be configured to perform one or more processes described herein, such as process 600 of FIG. 6, or a combination thereof. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 706. In some aspects, the reception component 702 may include one or more antennas, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 706. In some aspects, one or more other components of the apparatus 706 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The reception component 702 may receive, from a base station, one or more communications associated with accessing a cell associated with the base station. The selection component 708 may selectively access the cell associated with the base station based at least in part on a determination of whether the one or more communications provide an indication that the cell is dedicated for air-to-ground communications.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:
Aspect 1: A method of wireless communication performed by a user equipment (UE), comprising: receiving, from a base station, one or more communications associated with accessing a cell associated with the base station; and selectively accessing the cell associated with the base station based at least in part on a determination of whether the one or more communications provide an indication that the cell is dedicated for air-to-ground communications.
Aspect 2: The method of Aspect 1, wherein the one or more communications include a synchronization signal block (SSB), and selectively accessing the cell associated with the base station comprises: selectively accessing the cell associated with the base station based at least in part on a determination of whether the SSB includes a primary synchronization signal (PSS) sequence that indicates that the cell is dedicated for air-to-ground communications.
Aspect 3: The method of Aspect 1, wherein the one or more communications include a synchronization signal block (SSB), and selectively accessing the cell associated with the base station comprises: selectively accessing the cell associated with the base station based at least in part on a determination of whether the SSB includes a secondary synchronization signal (SSS) sequence that indicates that the cell is dedicated for air-to-ground communications.
Aspect 4: The method of Aspect 1, wherein the one or more communications include a physical broadcast channel (PBCH) communication, and selectively accessing the cell associated with the base station comprises: selectively accessing the cell associated with the base station based at least in part on a determination of whether a PBCH scrambling sequence indicates that the cell is dedicated for air-to-ground communications.
Aspect 5: The method of Aspect 1, wherein the one or more communications include a master information block (MIB), and selectively accessing the cell associated with the base station comprises: selectively accessing the cell associated with the base station based at least in part on a determination of whether the MIB includes an indication that the cell is dedicated for air-to-ground communications.
Aspect 6: The method of Aspect 1, wherein the one or more communications include a system information block (SIB) including remaining minimum system information (RMSI), and selectively accessing the cell associated with the base station comprises: selectively accessing the cell associated with the base station based at least in part on a determination of whether the RMSI includes an indication that the cell is dedicated for air-to-ground communications.
Aspect 7: The method of any of Aspects 1-6, wherein selectively accessing the cell associated with the base station comprises: accessing the cell based at least in part on determining that the one or more communications provide the indication that the cell is dedicated for air-to-ground communications.
Aspect 8: The method of any of Aspects 1-7, wherein the one or more communications include a synchronization signal block (SSB), and selectively accessing the cell associated with the base station comprises, based at least in part on determining that the one or more communications do not provide the indication that the cell is dedicated for air-to-ground communications: accessing the cell based at least in part on a determination that a reference signal received power (RSRP) measurement of the SSB satisfies a threshold; or refraining from accessing the cell based at least in part on a determination that the RSRP measurement of the SSB does not satisfy the threshold.
Aspect 9: The method of any of Aspects 1-8, wherein the one or more communications include a synchronization signal block (SSB), and selectively accessing the cell associated with the base station comprises, based at least in part on determining that the one or more communications do not provide the indication that the cell is dedicated for air-to-ground communications: accessing the cell based at least in part on a determination that a reference signal received power (RSRP) measurement of the SSB satisfies a threshold for a time duration; or refraining from accessing the cell based at least in part on a determination that the RSRP measurement of the SSB does not satisfy the threshold for the time duration.
Aspect 10: The method of any of Aspects 1-9, wherein selectively accessing the cell associated with the base station comprises, based at least in part on determining that the one or more communications do not provide the indication that the cell is dedicated for air-to-ground communications: measuring at least one of a power delay profile or Doppler measurement for a reference signal; and selectively accessing the cell based at least in part on the at least one of the power delay profile or the Doppler measurement.
Aspect 11: The method of Aspect 10, wherein the reference signal is a synchronization signal block or a demodulation reference signal.
Aspect 12: The method of any of Aspects 1-11, wherein selectively accessing the cell associated with the base station comprises, based at least in part on determining that the one or more communications do not provide the indication that the cell is dedicated for air-to-ground communications: measuring at least one of a power delay profile or Doppler measurement for a reference signal; transmitting, to the base station, an indication of the at least one of the power delay profile or the Doppler measurement; and receiving, from the base station, an indication of whether to access the cell.
Aspect 13: An apparatus for wireless communication at a device, comprising a processor; memory coupled with the processor; and instructions stored in the memory and executable by the processor to cause the apparatus to perform the method of one or more of Aspects 1-12.
Aspect 14: A device for wireless communication, comprising a memory and one or more processors coupled to the memory, the one or more processors configured to perform the method of one or more of Aspects 1-12.
Aspect 15: An apparatus for wireless communication, comprising at least one means for performing the method of one or more of Aspects 1-12.
Aspect 16: A non-transitory computer-readable medium storing code for wireless communication, the code comprising instructions executable by a processor to perform the method of one or more of Aspects 1-12.
Aspect 17: A non-transitory computer-readable medium storing a set of instructions for wireless communication, the set of instructions comprising one or more instructions that, when executed by one or more processors of a device, cause the device to perform the method of one or more of Aspects 1-12.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive, from a base station, one or more communications associated with accessing a cell associated with the base station; and
selectively access the cell associated with the base station based at least in part on a determination of whether the one or more communications provide an indication that the cell is dedicated for air-to-ground communications.

2. The UE of claim 1, wherein the one or more communications include a synchronization signal block (SSB), and the one or more processors, to selectively access the cell associated with the base station, are configured to:
selectively access the cell associated with the base station based at least in part on a determination of whether the SSB includes a primary synchronization signal (PSS) sequence that indicates that the cell is dedicated for air-to-ground communications.

3. The UE of claim 1, wherein the one or more communications include a synchronization signal block (SSB), and the one or more processors, to selectively access the cell associated with the base station, are configured to:
selectively access the cell associated with the base station based at least in part on a determination of whether the SSB includes a secondary synchronization signal (SSS) sequence that indicates that the cell is dedicated for air-to-ground communications.

4. The UE of claim 1, wherein the one or more communications include a physical broadcast channel (PBCH) communication, and the one or more processors, to selectively access the cell associated with the base station, are configured to:
selectively access the cell associated with the base station based at least in part on a determination of whether a PBCH scrambling sequence indicates that the cell is dedicated for air-to-ground communications.

5. The UE of claim 1, wherein the one or more communications include a master information block (MIB), and the one or more processors, to selectively access the cell associated with the base station, are configured to:
selectively access the cell associated with the base station based at least in part on a determination of whether the MIB includes an indication that the cell is dedicated for air-to-ground communications.

6. The UE of claim 1, wherein the one or more communications include a system information block (SIB) including remaining minimum system information (RMSI), and the one or more processors, to selectively access the cell associated with the base station, are configured to:
selectively access the cell associated with the base station based at least in part on a determination of whether the RMSI includes an indication that the cell is dedicated for air-to-ground communications.

7. The UE of claim 1, wherein the one or more processors, to selectively access the cell associated with the base station, are configured to:
access the cell based at least in part on determining that the one or more communications provide the indication that the cell is dedicated for air-to-ground communications.

8. The UE of claim 1, wherein the one or more communications include a synchronization signal block (SSB), and the one or more processors, to selectively access the cell associated with the base station, are configured to:
based at least in part on determining that the one or more communications do not provide the indication that the cell is dedicated for air-to-ground communications:
access the cell based at least in part on a determination that a reference signal received power (RSRP) measurement of the SSB satisfies a threshold, and
refrain from accessing the cell based at least in part on a determination that the RSRP measurement of the SSB does not satisfy the threshold.

9. The UE of claim 1, wherein the one or more communications include a synchronization signal block (SSB), and the one or more processors, to selectively access the cell associated with the base station, are configured to:
based at least in part on determining that the one or more communications do not provide the indication that the cell is dedicated for air-to-ground communications:
access the cell based at least in part on a determination that a reference signal received power (RSRP) measurement of the SSB satisfies a threshold for a time duration, and
refrain from accessing the cell based at least in part on a determination that the RSRP measurement of the SSB does not satisfy the threshold for the time duration.

10. The UE of claim 1, wherein the one or more processors, to selectively access the cell associated with the base station, are configured to:
based at least in part on determining that the one or more communications do not provide the indication that the cell is dedicated for air-to-ground communications:
measure at least one of a power delay profile or Doppler measurement for a reference signal, and
selectively access the cell based at least in part on the at least one of the power delay profile or the Doppler measurement.

11. The UE of claim 10, wherein the reference signal is a synchronization signal block or a demodulation reference signal.

12. The UE of claim 1, wherein the one or more processors, to selectively access the cell associated with the base station, are configured to:
based at least in part on determining that the one or more communications do not provide the indication that the cell is dedicated for air-to-ground communications:
measure at least one of a power delay profile or Doppler measurement for a reference signal;
transmit, to the base station, an indication of the at least one of the power delay profile or the Doppler measurement; and
receive, from the base station, an indication of whether to access the cell.

13. A method of wireless communication performed by a user equipment (UE), comprising:
receiving, from a base station, one or more communications associated with accessing a cell associated with the base station; and
selectively accessing the cell associated with the base station based at least in part on a determination of whether the one or more communications provide an indication that the cell is dedicated for air-to-ground communications.

14. The method of claim 13, wherein the one or more communications include a synchronization signal block (SSB), and selectively accessing the cell associated with the base station comprises:
selectively accessing the cell associated with the base station based at least in part on a determination of whether the SSB includes a primary synchronization signal (PSS) sequence that indicates that the cell is dedicated for air-to-ground communications.

15. The method of claim 13, wherein the one or more communications include a synchronization signal block (SSB), and selectively accessing the cell associated with the base station comprises:
selectively accessing the cell associated with the base station based at least in part on a determination of whether the SSB includes a secondary synchronization signal (SSS) sequence that indicates that the cell is dedicated for air-to-ground communications.

16. The method of claim 13, wherein the one or more communications include a physical broadcast channel (PBCH) communication, and selectively accessing the cell associated with the base station comprises:
selectively accessing the cell associated with the base station based at least in part on a determination of whether a PBCH scrambling sequence indicates that the cell is dedicated for air-to-ground communications.

17. The method of claim 13, wherein the one or more communications include a master information block (MIB), and selectively accessing the cell associated with the base station comprises:
selectively accessing the cell associated with the base station based at least in part on a determination of whether the MIB includes an indication that the cell is dedicated for air-to-ground communications.

18. The method of claim 13, wherein the one or more communications include a system information block (SIB) including remaining minimum system information (RMSI), and selectively accessing the cell associated with the base station comprises:
selectively accessing the cell associated with the base station based at least in part on a determination of whether the RMSI includes an indication that the cell is dedicated for air-to-ground communications.

19. The method of claim 13, wherein selectively accessing the cell associated with the base station comprises:
accessing the cell based at least in part on determining that the one or more communications provide the indication that the cell is dedicated for air-to-ground communications.

20. The method of claim 13, wherein the one or more communications include a synchronization signal block (SSB), and selectively accessing the cell associated with the base station comprises, based at least in part on determining that the one or more communications do not provide the indication that the cell is dedicated for air-to-ground communications:
accessing the cell based at least in part on a determination that a reference signal received power (RSRP) measurement of the SSB satisfies a threshold; or refraining from accessing the cell based at least in part on a determination that the RSRP measurement of the SSB does not satisfy the threshold.

21. The method of claim 13, wherein the one or more communications include a synchronization signal block (SSB), and selectively accessing the cell associated with the base station comprises, based at least in part on determining that the one or more communications do not provide the indication that the cell is dedicated for air-to-ground communications:
accessing the cell based at least in part on a determination that a reference signal received power (RSRP) measurement of the SSB satisfies a threshold for a time duration; or
refraining from accessing the cell based at least in part on a determination that the RSRP measurement of the SSB does not satisfy the threshold for the time duration.

22. The method of claim 13, wherein selectively accessing the cell associated with the base station comprises, based at least in part on determining that the one or more communications do not provide the indication that the cell is dedicated for air-to-ground communications:
measuring at least one of a power delay profile or Doppler measurement for a reference signal; and
selectively accessing the cell based at least in part on the at least one of the power delay profile or the Doppler measurement.

23. The method of claim 22, wherein the reference signal is a synchronization signal block or a demodulation reference signal.

24. The method of claim 13, wherein selectively accessing the cell associated with the base station comprises, based at least in part on determining that the one or more communications do not provide the indication that the cell is dedicated for air-to-ground communications:
measuring at least one of a power delay profile or Doppler measurement for a reference signal;
transmitting, to the base station, an indication of the at least one of the power delay profile or the Doppler measurement; and
receiving, from the base station, an indication of whether to access the cell

25. A non-transitory computer-readable medium storing a set of instructions for wireless communication, the set of instructions comprising:
one or more instructions that, when executed by one or more processors of a user equipment (UE), cause the UE to:
receive, from a base station, one or more communications associated with accessing a cell associated with the base station; and
selectively access the cell associated with the base station based at least in part on a determination of whether the one or more communications provide an indication that the cell is dedicated for air-to-ground communications.

26. The non-transitory computer-readable medium of claim 25, wherein the one or more instructions that cause the UE to selectively access the cell associated with the base station, when executed by the one or more processors of the UE, cause the UE to:
access the cell based at least in part on determining that the one or more communications provide the indication that the cell is dedicated for air-to-ground communications.

27. The non-transitory computer-readable medium of claim 25, wherein the one or more communications include a synchronization signal block (SSB), and wherein the one or more instructions that cause the UE to selectively access the cell associated with the base station, when executed by the one or more processors of the UE, cause the UE to:
based at least in part on determining that the one or more communications do not provide the indication that the cell is dedicated for air-to-ground communications:
access the cell based at least in part on a determination that a reference signal received power (RSRP) measurement of the SSB satisfies a threshold, and
refrain from accessing the cell based at least in part on a determination that the RSRP measurement of the SSB does not satisfy the threshold.

28. The non-transitory computer-readable medium of claim 25, wherein the one or more communications include a synchronization signal block (SSB), and wherein the one or more instructions that cause the UE to selectively access the cell associated with the base station, when executed by the one or more processors of the UE, cause the UE to:
based at least in part on determining that the one or more communications do not provide the indication that the cell is dedicated for air-to-ground communications:
access the cell based at least in part on a determination that a reference signal received power (RSRP) measurement of the SSB satisfies a threshold for a time duration, and
refrain from accessing the cell based at least in part on a determination that the RSRP measurement of the SSB does not satisfy the threshold for the time duration.

29. The non-transitory computer-readable medium of claim 25, wherein the one or more instructions that cause the UE to selectively access the cell associated with the base station, when executed by the one or more processors of the UE, cause the UE to:
based at least in part on determining that the one or more communications do not provide the indication that the cell is dedicated for air-to-ground communications:
measure at least one of a power delay profile or Doppler measurement for a reference signal, and
selectively access the cell based at least in part on the at least one of the power delay profile or the Doppler measurement.

30. An apparatus for wireless communication, comprising:
means for receiving, from a base station, one or more communications associated with accessing a cell associated with the base station; and
means for selectively accessing the cell associated with the base station based at least in part on a determination of whether the one or more communications provide an indication that the cell is dedicated for air-to-ground communications.
